(19) United States
(12) Patent Application Publication
(10) Pub. No.: US 2026/0287946 A1
(43) Pub. Date: Sep. 24, 2026

(54) DISPLAY DEVICE

(71) Applicants: InnoLux Corporation, Miao-Li County (TW); CARUX TECHNOLOGY PTE. LTD., APERIA (SG)

(72) Inventors: Che-Chang HU, Tainan (Tainan Science Park) (TW); Wei-Tong SHIH, Tainan (Tainan Science Park) (TW); Cheng-Tso CHEN, Miao-Li County (TW); Ching-Tsung SU, Tainan (Tainan Science Park) (TW); Shen-I YAN, Miao-Li County (TW); Pao-Chuan SU, Tainan (Tainan Science Park) (TW); Chi-Lin LIU, Tainan (Tainan Science Park) (TW)

(21) Appl. No.: 19/553,528

(22) Filed: Mar. 2, 2026

(30) Foreign Application Priority Data
Mar. 20, 2025 (CN) 202510330010.X

(51) Int. Cl. G02F 1/1335; G02F 1/1333; G02F 1/1339

(52) U.S. Cl. CPC G02F 1/133514; G02F 1/133368; G02F 1/13338; G02F 1/133512; G02F 1/13396

(57) ABSTRACT

A display device is provided. The display device includes a first substrate, a second substrate, a display medium layer, a first color-resistance unit, a second color-resistance unit, a third color-resistance unit, a fourth color-resistance unit, and a shading element. The display medium layer is sandwiched between the first substrate and the second substrate. The first color-resistance unit and the second color-resistance unit are disposed on the second substrate and located in the display area. The third color-resistance unit and the fourth color-resistance unit are disposed on the second substrate and located in the sensing area. The shading element is disposed on the second substrate and located in the display area. In the display area, the shading element is disposed between the first color-resistance unit and the second color-resistance unit. In the sensing area, the third color-resistance unit contacts the fourth color-resistance unit.

### CROSS REFERENCE TO RELATED APPLICATIONS

This application claims priority of China Patent Application No. 202510330010.X, filed on March 20, 2025, the entirety of which is incorporated by reference herein.

### BACKGROUND

### TECHNICAL FIELD

The present disclosure relates to a display device, and in particular it relates to a display device provided with a hidden camera.

### DESCRIPTION OF THE RELATED ART

When a conventional infrared camera is placed under a liquid-crystal display (LCD), it can experience interference from the components in the LCD, and it cannot achieve a good hiding effect, causing the detected image quality to be poor. In particular, the appearance of the sensing area is different from that of the display area, resulting in an obvious color difference, which causes the sensing area to fail to achieve a concealing effect, deteriorating the visual taste.

Therefore, the development of a display device that is equipped with a hidden camera and has high image quality is highly anticipated.

### SUMMARY

In accordance with one embodiment of the present disclosure, a display device is provided. The display device includes a first substrate, a second substrate, a display medium layer, a first color-resistance unit, a second color-resistance unit, a third color-resistance unit, a fourth color-resistance unit, and a shading element. The second substrate is disposed corresponding to the first substrate. The display medium layer is sandwiched between the first substrate and the second substrate. The first color-resistance unit and the second color-resistance unit are disposed on the second substrate and located in the display area. The second color-resistance unit is adjacent to the first color-resistance unit. The third color-resistance unit and the fourth color-resistance unit are disposed on the second substrate and located in the sensing area. The fourth color-resistance unit is adjacent to the third color-resistance unit. The shading element is disposed on the second substrate and located in the display area. In the display area, the shading element is disposed between the first color-resistance unit and the second color-resistance unit. In the sensing area, the third color-resistance unit contacts the fourth color-resistance unit.

In accordance with one embodiment of the present disclosure, a display device is provided. The display device includes a first substrate, a second substrate, a display medium layer, a first color-resistance unit, a second color-resistance unit, a first shading element, and a second shading element. The second substrate is disposed corresponding to the first substrate. The display medium layer is sandwiched between the first substrate and the second substrate. The first color-resistance unit and the second color-resistance unit are disposed on the second substrate and located in the display area. The second color-resistance unit is adjacent to the first color-resistance unit. The first shading element is disposed on the second substrate and disposed between the first color-resistance unit and the second color-resistance unit. The second shading element is disposed on the second substrate and is at least partially disposed in the sensing area. In the cross-sectional direction of the display device, the width of the second shading element is greater than or equal to the width of the sensing area.

### BRIEF DESCRIPTION OF THE DRAWINGS

The disclosure can be more fully understood from the following detailed description when read with the accompanying figures. It is worth noting that in accordance with standard practice in the industry, various features are not drawn to scale. In fact, the dimensions of the various features may be arbitrarily increased or reduced for clarity of discussion.

FIG. 1 shows a top view of a display device in accordance with one embodiment of the present disclosure;

FIG. 2 shows a schematic cross-sectional view of a display device in accordance with one embodiment of the present disclosure;

FIG. 3 shows a schematic cross-sectional view of a display device in accordance with one embodiment of the present disclosure;

FIG. 4 shows a variation of transmittance of a color-resistance unit and a shading element in a display device for light of different wavelengths in accordance with one embodiment of the present disclosure; and

FIG. 5 shows a schematic cross-sectional view of a display device in accordance with one embodiment of the present disclosure.

### DETAILED DESCRIPTION

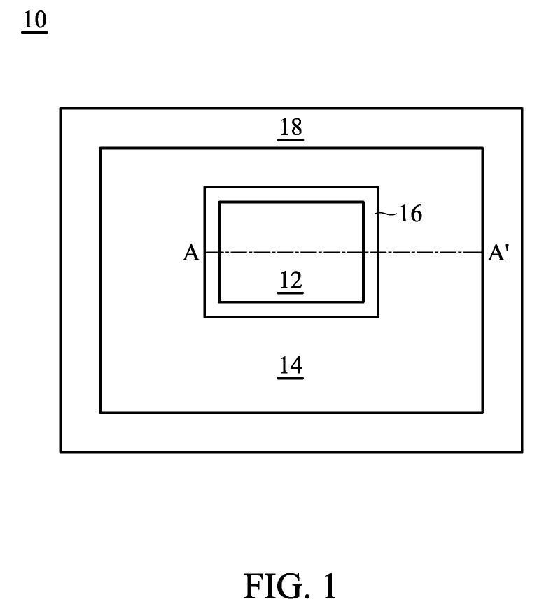

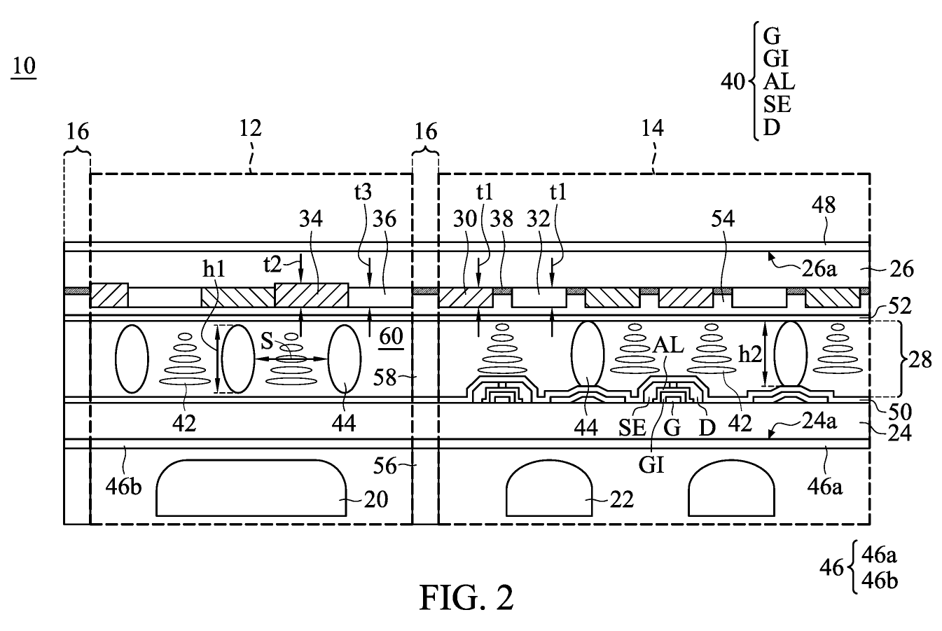

Referring to FIGS. 1 and 2, in accordance with one embodiment of the present disclosure, a display device 10 is provided. FIG. 1 is a top view of the display device 10. FIG. 2 is a schematic cross-sectional view obtained by FIG. 1 taken along a A-A’ cross-sectional line.

As shown in FIG. 1, the display device 10 includes a sensing area 12, a display area 14, an intermediate area 16, and a peripheral area 18. In accordance with some embodiments, the sensing area 12 may be located at any position within the display area 14, for example, at a central position (as shown in FIG. 1) or at a position adjacent to the peripheral area 18. Referring to FIG. 1, the display area 14 surrounds the sensing area 12. The intermediate area 16 is located between the sensing area 12 and the display area 14. The peripheral area 18 surrounds the display area 14. Referring to FIG. 2, the component structures disposed in the sensing area 12, the display area 14, and the intermediate area 16 are further described.

As shown in FIG. 2, the display device 10 includes an infrared-light sensing component 20, a visible-light light-emitting component 22, a first substrate 24, a second substrate 26, a display medium layer 28, a first color-resistance unit 30, a second color-resistance unit 32, a third color-resistance unit 34, a fourth color-resistance unit 36, and a shading element 38. The infrared-light sensing component 20 is disposed below the first substrate 24 and is located in the sensing area 12. The visible-light light-emitting component 22 is disposed below the first substrate 24 and is located in the display area 14. The second substrate 26 is disposed corresponding to the first substrate 24. The display medium layer 28 is sandwiched between the first substrate 24 and the second substrate 26. The first color-resistance unit 30 is disposed on the second substrate 26 and is located in the display area 14. The second color-resistance unit 32 is disposed on the second substrate 26, located in the display area 14, and adjacent to the first color-resistance unit 30. The third color-resistance unit 34 is disposed on the second substrate 26 and is located in the sensing area 12. The fourth color-resistance unit 36 is disposed on the second substrate 26, located in the sensing area 12, and adjacent to the third color-resistance unit 34. The shading element 38 is disposed on the second substrate 26 and is located in the display area 14. It is worth noting that, in the display area 14, the shading element 38 is disposed between the first color-resistance unit 30 and the second color-resistance unit 32. In the sensing area 12, the third color-resistance unit 34 contacts the fourth color-resistance unit 36, and no shading element is disposed in the sensing area 12.

In accordance with some embodiments, the infrared-light sensing component 20 may include, for example, an active infrared-light sensor or a passive infrared-light sensor, but the present disclosure is not limited thereto.

In accordance with some embodiments, the visible-light light-emitting component 22 may include a visible-light light-emitting diode (LED). In accordance with some embodiments, the visible-light light-emitting component 22 may emit, for example, white light, red light, green light, or blue light, but the present disclosure is not limited thereto.

In accordance with some embodiments, the first substrate 24 and the second substrate 26 may include a glass substrate, a sapphire substrate, a ceramic substrate, a graphite substrate, a metal substrate, a polyimide (PI) substrate or a polyethylene terephthalate (PET) substrate but the present disclosure is not limited thereto. In accordance with some embodiments, the first substrate 24 may include electronic components 40, such as active components or passive components, and related connection circuits (not shown), such as gate lines or data lines, but the present disclosure is not limited thereto. In accordance with some embodiments, the active component may include, for example, a thin-film transistor (TFT) or a diode, but the present disclosure is not limited thereto. In accordance with some embodiments, the passive component may include, for example, a resistor, a capacitor, or an inductor, but the present disclosure is not limited thereto. In accordance with some embodiments, the electronic component 40 includes a gate G, a gate insulating layer GI, a semiconductor layer AL, a source SE and a drain D.

In accordance with some embodiments, the display medium layer 28 may include, for example, liquid crystals 42 and spacers 44 disposed therein, but the present disclosure is not limited thereto. In accordance with some embodiments, the height h1 of the spacers 44 in the sensing area 12 may be different from the height h2 of the spacers 44 in the display area 14. In accordance with some embodiments, the height h1 of the spacers 44 in the sensing area 12 may be greater than the height h2 of the spacers 44 in the display area 14. In accordance with some embodiments, in the sensing area 12, a padding structure (not shown) may be provided between the first substrate 24 and the display medium layer 28, such as, but not limited to, an insulating layer, to pad the spacers 44 in the display medium layer 28 in the sensing area 12. Specifically, the material of the padding structure may be the same as the gate insulating layer or the fill layer (not shown) on the source and drain, and the padding structure may be formed in the same process as the gate insulating layer and the fill layer, but the present disclosure is not limited thereto. In accordance with some embodiments, when the above-mentioned padding structure is provided, the height h1 of the spacers 44 in the sensing area 12 may be substantially the same as the height h2 of the spacer 44 in the display area 14. In accordance with some embodiments, the density of the spacers 44 in the sensing area 12 may be different from the density of the spacers 44 in the display area 14. In accordance with some embodiments, the density of the spacers 44 in the sensing area 12 may be smaller than the density of the spacers 44 in the display area 14, so as to reduce the diffraction phenomenon in the sensing area 12. In accordance with some embodiments, the spacing S between the spacers 44 in the sensing area 12 is approximately between 50 μm and 10 mm, but the present disclosure is not limited thereto. In accordance with some embodiments, the refractive index of the spacers 44 may match the refractive index of the liquid crystals 42 to reduce diffraction in the sensing area 12 and the display area 14. In accordance with some embodiments, the transmittance of the spacers 44 to visible light (e.g., with a wavelength approximately between 400 nm and 700 nm) is greater than approximately 80%. In accordance with some embodiments, the transmittance of the spacers 44 to infrared light (e.g., with a wavelength approximately between 850 nm and 1,000 nm) is greater than about 80%. In accordance with some embodiments, no spacers are disposed in the sensing area 12.

In accordance with some embodiments, the first color-resistance unit 30, the second color-resistance unit 32, the third color-resistance unit 34, and the fourth color-resistance unit 36 may include, for example, a green color-resistance unit, a red color-resistance unit, or a blue color-resistance unit, but the present disclosure is not limited thereto. In accordance with some embodiments, the first color-resistance unit 30 and the second color-resistance unit 32 have a first thickness, and at least one of the third color-resistance unit 34 and the fourth color-resistance unit 36 has a different thickness than the first thickness. For example, the first color-resistance unit 30 and the second color-resistance unit 32 located in the display area 14 have a first thickness t1. The third color-resistance unit 34 located in the sensing area 12 has a second thickness t2. The fourth color-resistance unit 36 located in the sensing area 12 has a third thickness t3. The second thickness t2 and the third thickness t3 are different from the first thickness t1. The second thickness t2 is different from the third thickness t3. In accordance with some embodiments, the second thickness t2 of the third color-resistance unit 34 in the sensing area 12 increases by about 2 μm to 4 μm relative to the first thickness t1 of the first color-resistance unit 30 and the second color-resistance unit 32 in the display area 14. In accordance with some embodiments, the second thickness t2 of the third color-resistance unit 34 in the sensing area 12 is reduced by about 2 μm to 4 μm relative to the first thickness t1 of the first color-resistance unit 30 and the second color-resistance unit 32 in the display area 14. In accordance with some embodiments, the third thickness t3 of the fourth color-resistance unit 36 in the sensing area 12 increases by about 2 μm to 4 μm relative to the first thickness t1 of the first color-resistance unit 30 and the second color-resistance unit 32 in the display area 14. In accordance with some embodiments, the third thickness t3 of the fourth color-resistance unit 36 in the sensing area 12 is reduced by about 2 μm to 4 μm relative to the first thickness t1 of the first color-resistance unit 30 and the second color-resistance unit 32 in the display area 14. In the present disclosure, by adjusting the thickness of the color-resistance units in the sensing area 12, the transmittance of the infrared light of each color-resistance unit in the sensing area 12 is made to be consistent, so as to effectively reduce the diffraction phenomenon in the sensing area 12.

In accordance with some embodiments, the shading element 38 disposed in the display area 14 and located between the first color-resistance unit 30 and the second color-resistance unit 32 has a light-impenetrable property for, for example, the visible light band (e.g., with a wavelength approximately between 400 nm and 700 nm) and the infrared light (IR) band (e.g., with a wavelength approximately between 850 nm and 1,000 nm).

In accordance with some embodiments, a first functional layer 46 may be further disposed on the first side 24a of the first substrate 24. In accordance with some embodiments, a second functional layer 48 may be further disposed on the first side 26a of the second substrate 26. In accordance with some embodiments, the first functional layer 46 and the second functional layer 48 may include optical films, such as an anti-reflection film, a polarizing film, a dual brightness enhancement film (DBEF), or a brightness enhancement film (BEF), but the present disclosure is not limited thereto. In accordance with some embodiments, the first functional layer 46 and the second functional layer 48 may include, for example, a single-layer optical film, a double-layer optical film, or a multi-layer optical film, and the number of layers of the optical film is not limited. In accordance with some embodiments, the second functional layer 48 may be a polarizing film or an anti-reflection film, but the present disclosure is not limited thereto.

In some embodiments, the first functional layer 46 includes a first portion 46a corresponding to the display area 14 and a second portion 46b corresponding to the sensing area 12. The optical film located in the first portion 46a is different from the optical film located in the second portion 46b. For example, the optical film located at the first portion 46a may be a reflective sheet, a dual brightness enhancement film (DBEF), or a brightness enhancement film. The optical film located at the second portion 46b may be a wavelength filter, a polarizing film, or a quarter-wave plate, but the present disclosure is not limited thereto.

In accordance with some embodiments, a first alignment layer 50 may be further disposed between the first substrate 24 and the display medium layer 28. In accordance with some embodiments, a second alignment layer 52 may be further disposed between the second substrate 26 and the display medium layer 28. The first alignment layer 50 and the second alignment layer 52 can make the arrangement direction of the liquid crystals 42 uniform and provide the liquid crystals 42 with a pre-tilt angle, so that the liquid crystals 42 can achieve an improved rotation effect. In accordance with some embodiments, the first alignment layer 50 and the second alignment layer 52 may include, for example, polyimide (PI) material, but the present disclosure is not limited thereto.

In accordance with some embodiments, a planar layer 54 may be further disposed between the second substrate 26 and the display medium layer 28 to cover the first color-resistance unit 30, the second color-resistance unit 32, the third color-resistance unit 34, the fourth color-resistance unit 36, and the shading element 38.

In accordance with some embodiments, a retaining wall 56 may be further disposed below the first substrate 24 in the intermediate area 16 between the sensing area 12 and the display area 14 to surround the infrared-light sensing component 20.

In accordance with some embodiments, a plastic frame 58 may be further disposed between the first substrate 24 and the second substrate 26 and in the intermediate area 16 between the sensing area 12 and the display area 14 to form an accommodate space 60 for accommodating the liquid crystals 42 and the spacers 44.

In accordance with some embodiments, related connection lines (not shown), such as gate lines or data lines, may be disposed in the intermediate area 16.

In accordance with the embodiment shown in FIG. 2, the RGB color-resistance units are disposed in the sensing area, but no shading element is disposed. Since the RGB color-resistance units have low reflection for the visible-light band (e.g., with a wavelength approximately between 400 nm and 700 nm), and has high penetration and no absorption for the infrared-light band (e.g., with a wavelength approximately between 850 nm and 1,000 nm), when the RGB color-resistance units are retained in the sensing area and fully distributed in the area, a low-reflection effect can be achieved for the front visual of the sensing area, the color difference (ΔE) between the sensing area and the display area can be reduced, and the consistent-black effect can be improved. In addition, since the RGB color resistance units have high-penetration characteristics for the infrared-light band, the infrared-light sensing component can also maintain normal operation.

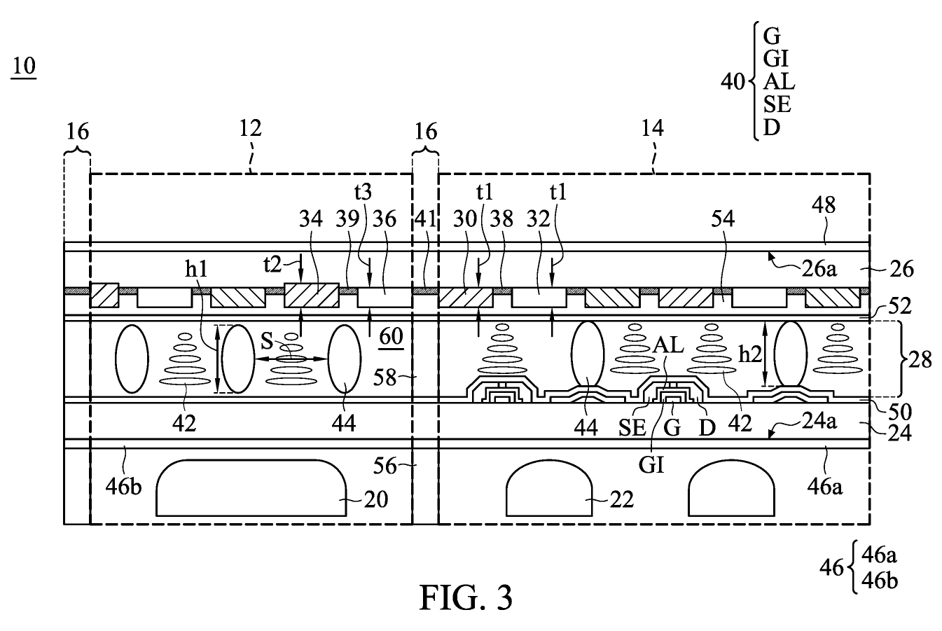

Referring to FIG. 3, in accordance with one embodiment of the present disclosure, a display device 10 is provided. FIG. 3 is a schematic cross-sectional view of the display device 10.

As shown in FIG. 3, the display device 10 includes an infrared-light sensing component 20, a visible-light light-emitting component 22, a first substrate 24, a second substrate 26, a display medium layer 28, a first color-resistance unit 30, a second color-resistance unit 32, a third color-resistance unit 34, a fourth color-resistance unit 36, a first shading element 38, and a second shading element 39. Differently from FIG. 2, the second shading element 39 is disposed on the second substrate 26 and is located in the sensing area 12. It is worth noting that, in the display area 14, the first shading element 38 is disposed between the first color-resistance unit 30 and the second color-resistance unit 32. In the sensing area 12, the second shading element 39 is disposed between the third color-resistance unit 34 and the fourth color-resistance unit 36. The infrared-light transmittance of the second shading element 39 is greater than that of the first shading element 38.

The embodiment of the display device 10 shown in FIG. 3 is similar to the embodiment of the display device 10 shown in FIG. 2, and the main difference lies in the configuration of the shading element. In FIG. 3, in the sensing area 12, the second shading element 39 is further disposed between the third color-resistance unit 34 and the fourth color-resistance unit 36. The other similar parts will not be repeated here.

In accordance with some embodiments, the second shading element 39 disposed in the sensing area 12 and located between the third color-resistance unit 34 and the fourth color-resistance unit 36 has low-reflection and low-penetration characteristics for, for example, the visible-light band, and has high-penetration characteristics for, for example, the infrared-light band. In accordance with some embodiments, the infrared-light transmittance of the second shading element 39 is greater than about 80%.

In accordance with some embodiments, a third shading element 41 disposed in the intermediate area 16 and located between the fourth color-resistance unit 36 and the first color-resistance unit 30 may have the same light-transmittance property as the first shading element 38. In accordance with some embodiments, the light-transmittance characteristic of the third shading element 41 disposed in the intermediate area 16 and located between the fourth color-resistance unit 36 and the first color-resistance unit 30 may be the same as that of the second shading element 39.

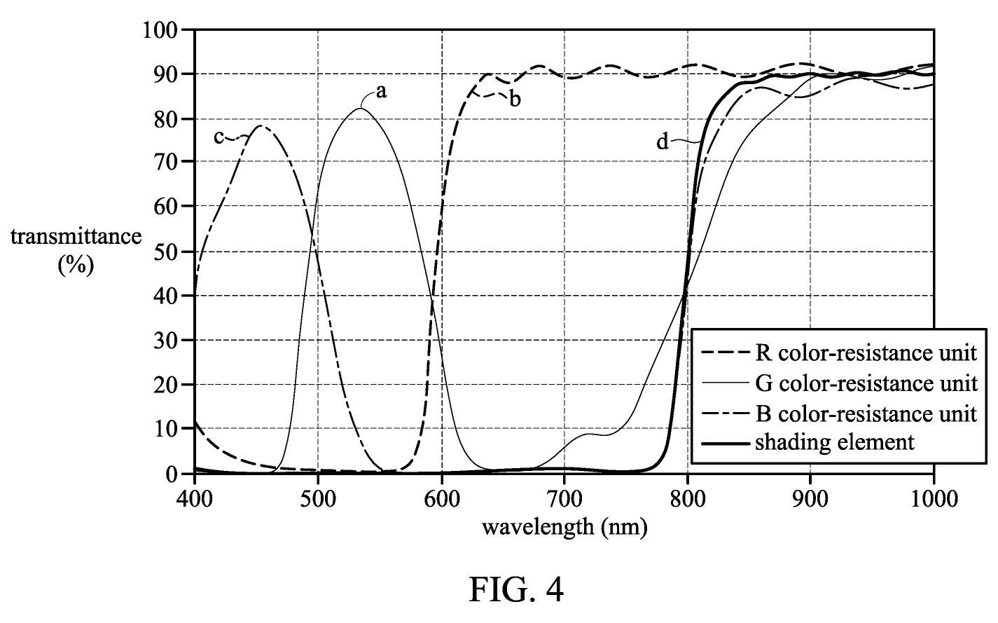

Referring to FIG. 4, the diagram further illustrates the variations of transmittance of the color-resistance unit (e.g., the third color-resistance unit 34 or the fourth color-resistance unit 36) and the second shading element 39 in the sensing area 12 of the display device 10 for light of different wavelengths, which are represented by curves a, b, c, and d, respectively.

As shown in FIG. 4, when the third color-resistance unit 34 or the fourth color-resistance unit 36 is a green color-resistance unit (such as curve a), it allows green visible light with a wavelength of approximately between 510 nm and 570 nm (510 nm≤wavelength≤570 nm) and infrared light with a wavelength of approximately between 850 nm and 1,000 nm (850 nm≤wavelength≤1,000 nm) to penetrate.

In the present disclosure, the second shading element that allows infrared light (IR) to penetrate is introduced into the sensing area. The second shading element has low-reflection and low-penetration characteristics in the visible-light band, and high-penetration characteristics in the infrared-light band. The RGB color-resistance has low-reflection characteristics in the visible-light band, and high-penetration and non-absorption characteristics in the infrared-light band. These achieve a low-reflection effect on the front visual of the sensing area, and reduce the color difference (ΔE) between the sensing area and the display area. The second shading element disposed in the sensing area can match the first shading element disposed in the display area to further improve the consistent-black effect. In addition, since the RGB color-resistance units have high-penetration characteristics for the infrared-light band, the infrared-light sensing component can also maintain normal operation. Furthermore, the thickness of the color-resistance units and the shading element in the sensing area can be further adjusted to change the transmittance, so that the transmittance of the color-resistance units and the shading element in the sensing area for the infrared-light band tends to be consistent, thereby reducing the diffraction phenomenon.

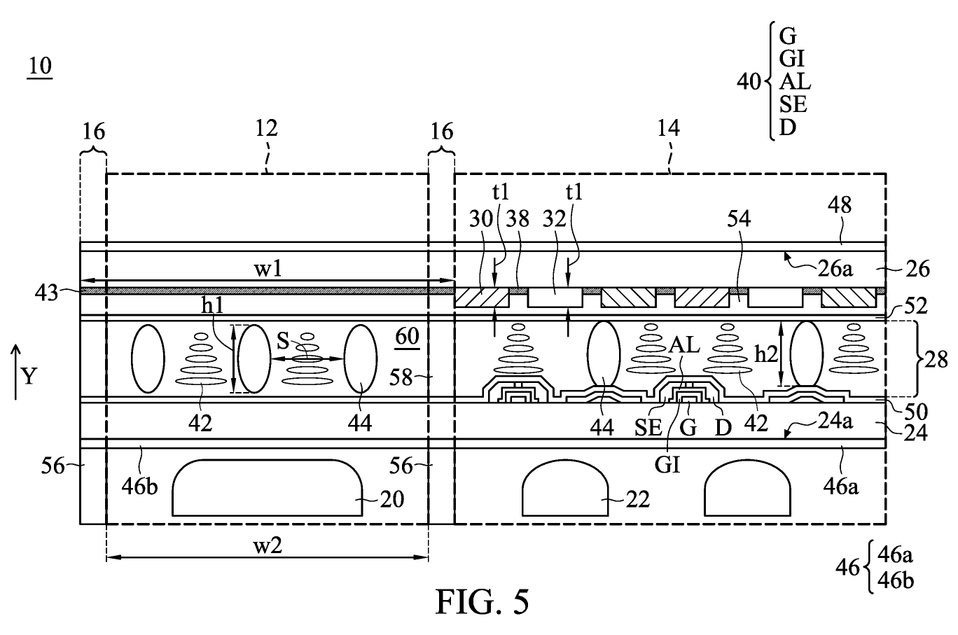

Referring to FIG. 5, in accordance with one embodiment of the present disclosure, a display device 10 is provided. FIG. 5 is a schematic cross-sectional view of the display device 10.

As shown in FIG. 5, the display device 10 includes an infrared-light sensing component 20, a visible-light light-emitting component 22, a first substrate 24, a second substrate 26, a display medium layer 28, a first color-resistance unit 30, a second color-resistance unit 32, a first shading element 38, and a fourth shading element 43. The fourth shading element 43 is disposed on the second substrate 26, and is at least partially disposed in the sensing area 12. It is worth noting that, in the display area 14, the first shading element 38 is disposed between the first color-resistance unit 30 and the second color-resistance unit 32. In the sensing area 12, the fourth shading element 43 extends toward the periphery of the sensing area 12 into the intermediate area 16 and is adjacent to the display area 14. In addition, no color-resistance unit is disposed in the sensing area 12. In addition, in the cross-sectional direction Y of the display device 10, the width w1 of the fourth shading element 43 is greater than or equal to the width w2 of the sensing area 12. Here, the width w1 of the fourth shading element 43 may be defined as the total width of the fourth shading element 43 extending in the sensing area 12 and the intermediate area 16 (adjacent to the edge of the display area 14) in the cross-sectional direction Y of the display device 10. The width w2 of the sensing area 12 may include the following two definitions. When the retaining walls are provided, the width w2 of the sensing area 12 may be defined as the distance between the retaining walls 56 on both sides in the cross-sectional direction Y of the display device 10 (as shown in FIG. 5 ). When the retaining wall is not provided, the width w2 of the sensing area 12 may be defined as the width of the infrared-light sensing component 20 itself or the width of the infrared-light sensing component 20 itself appropriately extended to both sides in the cross-sectional direction Y of the display device 10 (not shown).

The embodiment of the display device 10 shown in FIG. 5 is similar to the embodiment of the display device 10 shown in FIG. 2, and the main difference lies in the configuration of the color-resistance units and the shading elements. In FIG. 5, the fourth shading element 43 is comprehensively disposed in the sensing area 12 and extends outward into the intermediate area 16 adjacent to the display area 14. There is no color-resistance unit disposed in the sensing area 12. The other similar parts will not be repeated here.

In accordance with some embodiments, the first shading element 38 disposed in the display area 14 and located between the first color-resistance unit 30 and the second color-resistance unit 32 has a light-impenetrable property for, for example, a visible-light band (for example, with a wavelength approximately between 400 nm and 700 nm) and, for example, an infrared-light band (for example, with a wavelength approximately between 850 nm and 1,000 nm).

In accordance with some embodiments, the fourth shading element 43 comprehensively disposed in the sensing area 12 and extending outward into the intermediate area 16 adjacent to the display area 14 has low-reflection and low-penetration characteristics for, for example, the visible-light band, and has high-penetration characteristics for, for example, the infrared-light band. In accordance with some embodiments, the infrared-light transmittance of the fourth shading element 43 is greater than about 80%.

In the present disclosure, the fourth shading element that allows infrared light (IR) to penetrate is introduced into the sensing area. The fourth shading element has low-reflection and low-penetration characteristics in the visible-light band, and high-penetration characteristics in the infrared-light band. This achieves a low-reflection effect on the front visual of the sensing area, and reduces the color difference (ΔE) between the sensing area and the display area to improve the consistent-black effect. In addition, since the fourth shading element has high-penetration characteristics for the infrared-light band, the infrared-light sensing component can also maintain normal operation.

In accordance with some embodiments, the light-transmittance characteristics of the first shading element 38 in the display area 14 may be further adjusted to be the same as those of the fourth shading element 43 in the sensing area 12, for example, having low-reflection and low-transmittance characteristics for the visible-light band and high-transmittance characteristics for the infrared-light band. At this time, the transmittance of the first shading element 38 to the infrared light is greater than about 80%.

In the present disclosure, the sensing area provided with the infrared-light sensing components is located in the display area. By changing the design of the color-resistance units or the shading elements in the sensing area, the infrared-light sensing components in the sensing area are concealed, and the color difference (ΔE) between the sensing area and the display area is reduced to improve the visual taste of the overall black appearance. Since the sensing area is not displayed, there will be no problem of mixed light. In the present disclosure, all array components in the sensing area are removed (including metal parts), and the color-resistance units or shading elements are retained at the edge of the sensing area to shield the metal parts of the array components in the display area. Therefore, there will be no problem of metal reflection. The present disclosure can be applied to a driver monitoring system (DMS), and the obtained image clarity meets the requirements of AI algorithms.

What is claimed is:

1. A display device, comprising:
a first substrate;
a second substrate disposed corresponding to the first substrate;
a display medium layer sandwiched between the first substrate and the second substrate;
a first color-resistance unit disposed on the second substrate and located in a display area;
a second color-resistance unit disposed on the second substrate and located in the display area, adjacent to the first color-resistance unit;
a third color-resistance unit disposed on the second substrate and located in a sensing area;
a fourth color-resistance unit disposed on the second substrate and located in the sensing area, adjacent to the third color-resistance unit; and
a shading element disposed on the second substrate and located in the display area,
wherein, in the display area, the shading element is disposed between the first color-resistance unit and the second color-resistance unit, and in the sensing area, the third color-resistance unit contacts the fourth color-resistance unit.

2. The display device as claimed in claim 1, wherein, in the sensing area, no shading element is disposed.

3. The display device as claimed in claim 1, wherein the first color-resistance unit and the second color-resistance unit have a first thickness, and at least one of the third color-resistance unit and the fourth color-resistance unit has a thickness that is different from the first thickness.

4. The display device as claimed in claim 1, further comprising a plurality of spacers disposed in the display medium layer.

5. The display device as claimed in claim 4, wherein the spacers in the sensing area have a height different from that of the spacers in the display area.

6. The display device as claimed in claim 4, wherein the spacers in the sensing area have a density different from that of the spacers in the display area.

7. The display device as claimed in claim 1, further comprising an infrared-light sensing component disposed below the first substrate and located in the sensing area.

8. The display device as claimed in claim 1, further comprising a visible-light light-emitting component disposed below the first substrate and located in the display area.

9. The display device as claimed in claim 1, further comprising a planar layer disposed between the second substrate and the display medium layer to cover the first color-resistance unit, the second color-resistance unit, the third color-resistance unit, the fourth color-resistance unit, and the shading element.

10. The display device as claimed in claim 7, further comprising a retaining wall disposed below the first substrate in an intermediate area between the sensing area and the display area to surround the infrared-light sensing component.

11. A display device, comprising:
a first substrate;
a second substrate disposed corresponding to the first substrate;
a display medium layer sandwiched between the first substrate and the second substrate;
a first color-resistance unit disposed on the second substrate and located in a display area;
a second color-resistance unit disposed on the second substrate and located in the display area, adjacent to the first color-resistance unit;
a first shading element disposed on the second substrate and disposed between the first color-resistance unit and the second color-resistance unit; and
a second shading element disposed on the second substrate, wherein at least a part of the second shading element is disposed in a sensing area,
wherein, in a cross-sectional direction of the display device, the second shading element has a width that is greater than or equal to that of the sensing area.

12. The display device as claimed in claim 11, wherein the second shading element is adjacent to the display area.

13. The display device as claimed in claim 11, wherein the second shading element has an infrared-light transmittance greater than 80%.

14. The display device as claimed in claim 13, wherein the first shading element and the second shading element have the same material.

15. The display device as claimed in claim 11, further comprising a third color-resistance unit and a fourth color-resistance unit, wherein the third color-resistance unit is disposed on the second substrate and located in the sensing area, and the fourth color-resistance unit is disposed on the second substrate, located in the sensing region, and adjacent to the third color-resistance unit.

16. The display device as claimed in claim 15, wherein, in the sensing area, the second shading element is disposed between the third color-resistance unit and the fourth color-resistance unit, and the second shading element has an infrared-light transmittance greater than that of the first shading element.

17. The display device as claimed in claim 15, wherein the first color-resistance unit and the second color-resistance unit have a first thickness, and at least one of the third color-resistance unit and the fourth color-resistance unit has a thickness that is different from the first thickness.

18. The display device as claimed in claim 11, wherein the second shading element extends into an intermediate area between the sensing area and the display area.

19. The display device as claimed in claim 11, wherein the second shading element is comprehensively disposed in the sensing area.

20. The display device as claimed in claim 11, wherein no color-resistance unit is disposed in the sensing area.
